(19) United States
(12) Patent Application Publication
(10) Pub. No.: US 2006/0000370 A1
(43) Pub. Date: Jan. 5, 2006

(54) Nut de-shelling device and method

(76) Inventor: Farid Fred Poursayadi, Burbank, CA (US)

Correspondence Address: CHRISTIE, PARKER & HALE, LLP, PO BOX 7068, PASADENA, CA, 91109-7068, US

(21) Appl. No.: 10/884,411

(22) Filed: Jul. 1, 2004

(51) Int. Cl. A47J 17/00; A23N 5/00

(52) U.S. Cl. 99/568

(57) ABSTRACT

A nut de-shelling device. The device has a plurality of nut holder carried on a moving carriage member. Each nut holder has a pair of rotatable clamping members that securely hold the nut without regard to the orientation of the nut held therein, but permit rotation of the clamped nut relative to the moving carriage member. The device further includes a nut shell cutter that makes a cut line through the shell of the nut. The device also includes a releaser that moves the pair of rotatable clamping members apart from each other to release the nut with its shell cut.

### FIELD OF THE INVENTION

The invention is related to the field of food processing equipment and method, and more particularly to a device and method for de-shelling a variety of hard shelled objects such as nuts.

### BACKGROUND OF THE INVENTION

Presently, nuts are de-shelling by the application of a crushing force or high impact force to the outside of the shell, or by accelerating the nut against a hard surface. With either method, this force crushes or shatters the shell, and permits the seed or meat inside to be accessed. In the case of very hard nuts, such as walnuts and macadamia nuts, a considerable amount of force is required to deflect the somewhat flexible shell walls beyond a point of breakage, after which the shell wall cracks and breaks.

In the case of cashew nuts, commercial processing units use foot operated shell cutters (mechanical device) for shelling. This device consists of a pair of blades (knives) shaped in the contour of half a nut which could be operated by foot. The nuts have to be grouped into various sizes, each size matching a pair of blades of appropriate size. The blades cut through the shell all around the nut, leaving the kernel untouched.

After shelling, the kernels and shell pieces are separated manually. However, some of this force used to crack the shell may end up being transferred to nut meat, which can cause it to break into pieces. These pieces must then be collected, which can often be required to be taken care of manually or with additional machinery, which raises the cost of de-shelling nuts.

In the case of most nuts, whole nut meat pieces commands a higher value than broken pieces.

Accordingly, it would be advantageous to have a way to de-shell nuts in such a way that permit a higher percentage of whole nut meat pieces to be collected, and do so in a fast, cost-effective manner.

### SUMMARY OF THE INVENTION

The invention provides a nut de-shelling device, comprising:
a nut holding unit; and
a nut shell cutter that makes a cut line through the shell of the nut.

The invention further provides a nut de-shelling device, comprising:
a plurality of nut holder carried on a moving carriage member, with each nut holder having a pair of rotatable clamping members that securely hold the nut without regard to the orientation of the nut held therein, but permit rotation of the clamped nuts relative to the moving carriage member;
a nut shell cutter that makes a cut line through the shell of the nut; and
a releaser that moves the pair of rotatable clamping members apart from each other to release the nut with its shell cut.

The invention yet further provides a nut de-shelling device, comprising:
a nut holder; and
a nut shell saw that makes a saw line through the shell of the nut.

The invention also provides a method for de-shelling nuts, comprising the steps of:
holding a nut; and
sawing a saw line through the shell of the nut around a perimeter of the nut to separate the shell from the nut's meat.

### BRIEF DESCRIPTION OF THE DRAWINGS

These and other features, aspects, and advantages of the present invention will become better understood with regard to the following description, appended claims, and accompanying drawings where:

FIG. 1 is a top front perspective view showing an exemplary embodiment of a nut de-shelling device of the invention.

FIG. 2 is a top view of the nut de-shelling device of FIG. 1.

FIG. 3 is a left side view of the nut de-shelling device of FIG. 1.

FIG. 4A is a top left perspective detail showing an exemplary embodiment of the nut holder.

FIG. 4B is a top right perspective detail showing an embodiment of the nut holder of FIG. 4A.

FIG. 5 is a top front perspective showing a nut being captured by the nut holder.

FIG. 6 is a top left perspective view showing the nut holder.

FIG. 7 is a rear bottom perspective view showing the nut rotator.

FIG. 8 is a left side detail view showing an exemplary embodiment of the cutter unit.

FIG. 9 is a top rear perspective view showing the nut rotator.

FIG. 10 is a detail showing a nut having its shell being cut.

FIG. 11 is a rear detail view of the nut de-shelling device of FIG. 1.

FIGS. 12A-E are details of various cutters for the shell.

FIG. 13 is a diagrammatic view showing the nut holder release mechanism.

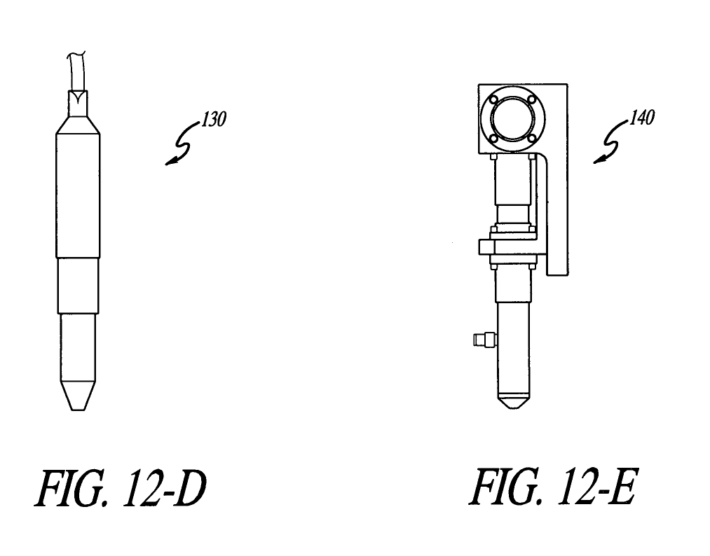

### DETAILED DESCRIPTION OF THE INVENTION

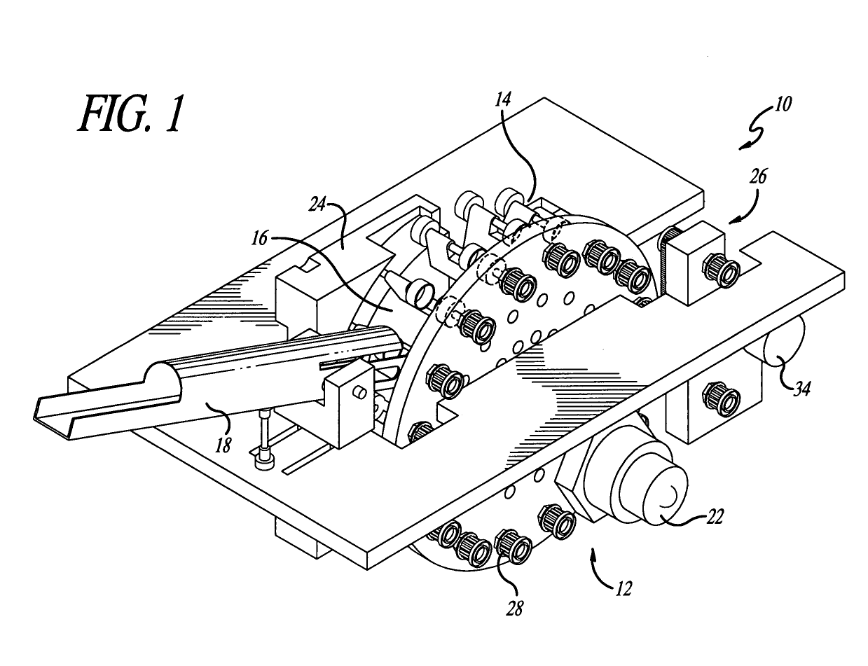

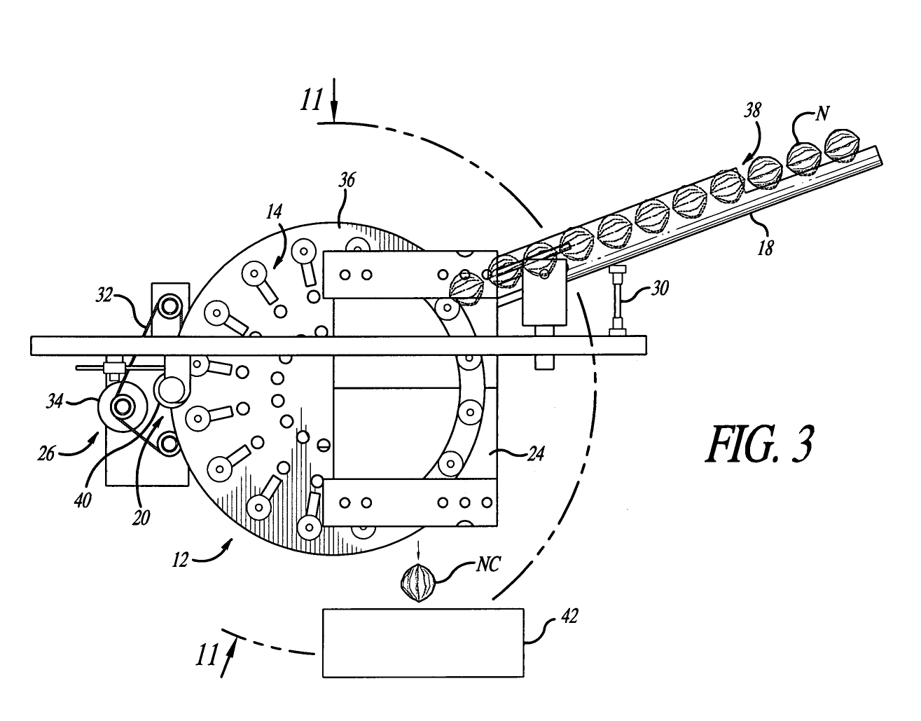

Referring to FIG. 1, there is shown a front perspective view showing an embodiment of a nut de-shelling device 10 of the invention. It comprises a rotating carriage member 12 that carries a plurality of nut holders 14. Nuts (not shown) are deposited at a nut loading station 16 where nuts are engaged with the nut holders 14. A nut feeder 18 is used to deliver the nuts to the nut loading station 16. A shell cutter (shown as 20 in FIG. 3) is used to cut the nut's shell. The carriage member 12 can turn on a spindle 22 (e.g. powered by a motor.) A nut holder release unit 24 is used to permit the nut holder to hold a nut from the nut loading station 16, during the shell cutting process, and to cause a nut to be released after the nut's shell has been cut. A nut holder rotator 26 is also shown. Turning gears 28 of the nut holders 14 are shown. For clarity of presentation, the various motors, pneumatics, hydraulics, control electronics, etc. are not shown.

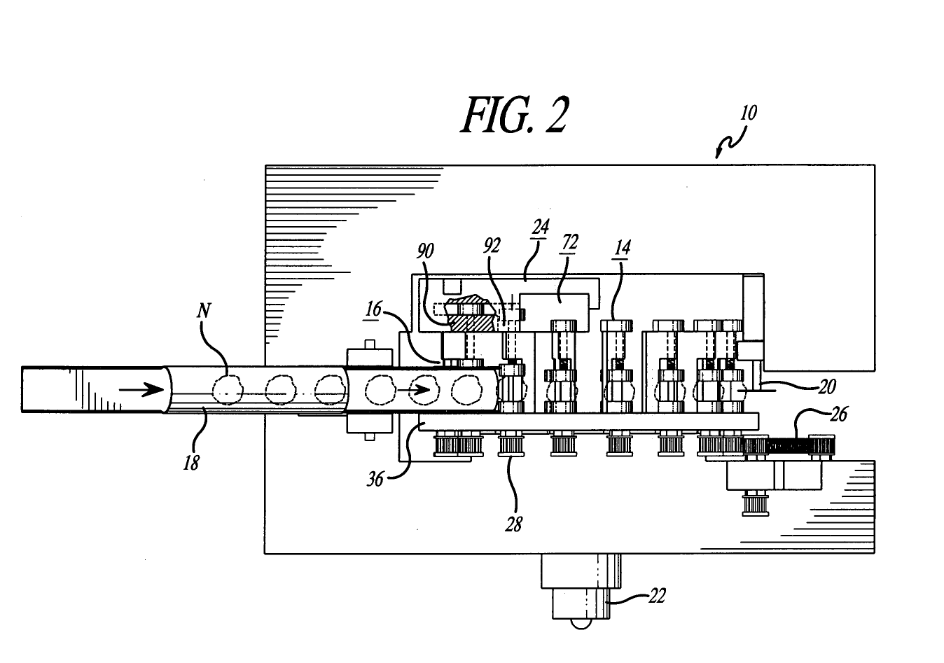

FIG. 2 is a top view of the exemplary nut de-shelling device 10 of FIG. 1 being used to hold and cut the shell of nuts, and better shows the carriage member 12 carrying a number of nut holders 14, and shows the various major portions of the exemplary nut de-shelling device 10, including the nut loading station 16, the nut feeder 18, the shell cutter 20, the spindle 22 for turning the carriage member 12, the nut holder release unit 24, and the nut holder rotator 26.

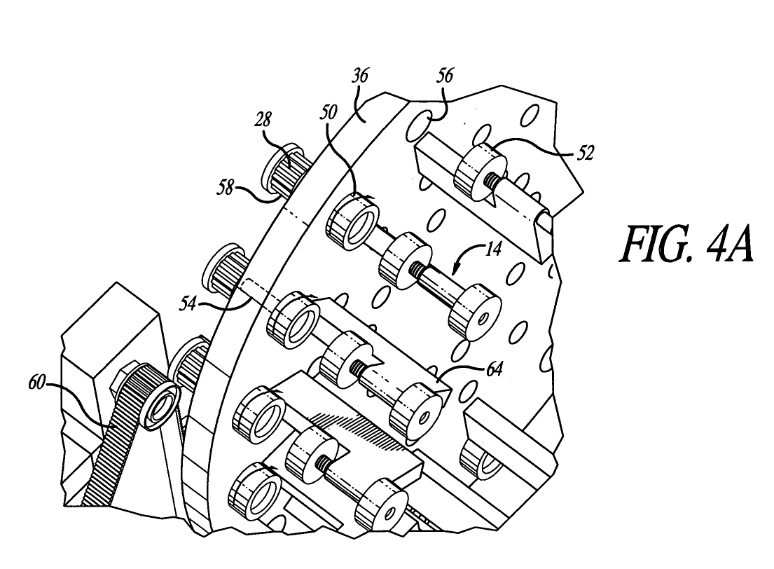

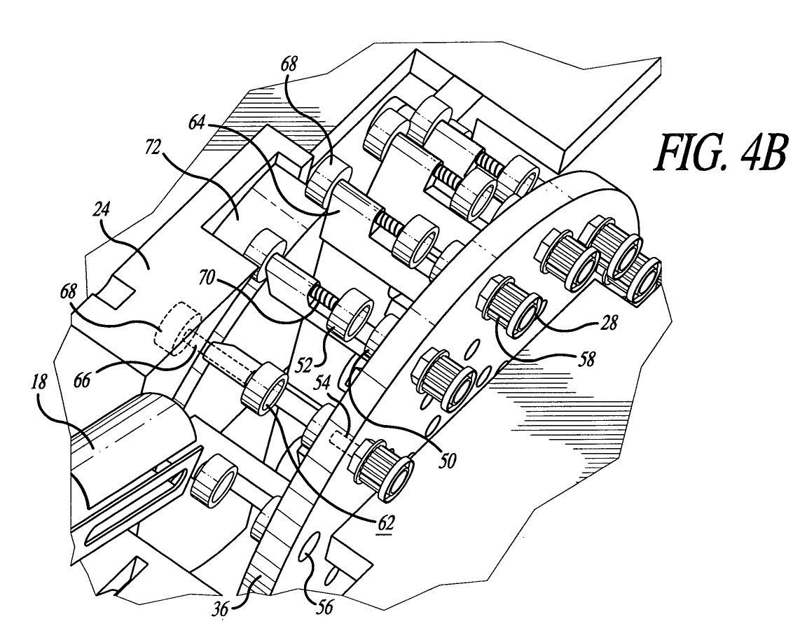

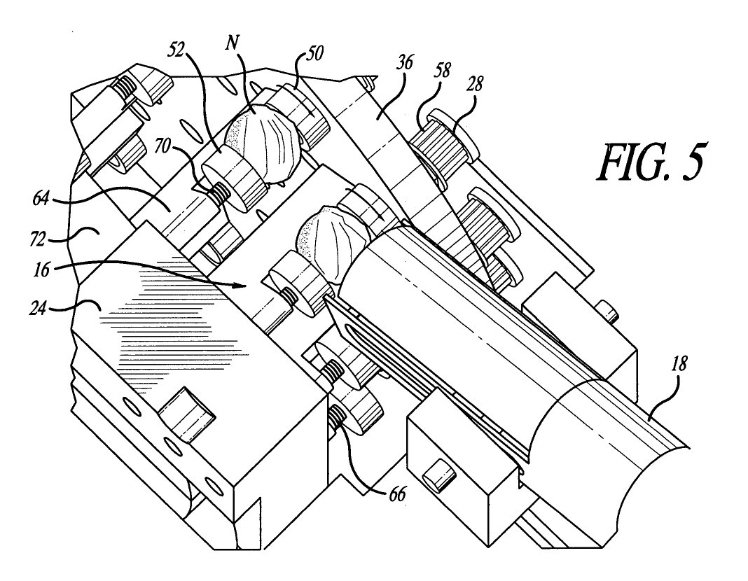

FIG. 3 is a rear view of the nut de-shelling device 10 of FIG. 1. The plurality of nut holders 14 are shown oriented around the carriage unit 12. In operation, the carriage unit 12 can comprise a rotating disk 36 to which are attached the holders 14. In the view of FIG. 3, the carriage unit rotates counterclockwise. The nut holder rotator 26 can comprise a belt 32 that is turned by a motor 34 (e.g. an electrical). However, other known motive devices can be used to turn the belt. As the carriage unit rotates, the turning gear 28 will be brought into contact with the moving belt 32, which will cause the turning gear 28 to rotate. Any nut “N” held by the nut holder 14 whose turning gear 28 is being turned will also turn, and a cutting blade 40 of the shell cutter 20 will ride on the turning shell and cut through the shell. After the shell is cut, the nut will continue to be carried by the nut holder 14. When it reaches a pre-determined position, the nut holder 14 will engage with the nut holder release unit 24, which permits the nut with a cut shell “NC” to drop downwardly. A container 42 is shown as a receptacle for nuts with cut shells. The nut feeder 18 used to deliver nuts to the nut loading station 16 can be provided as gravity feed channel 38 with a slant adjuster 30. The slant adjuster 30 can be adjusted the relative degree of slant of the gravity feed channel 38 to ensure that nuts slide down properly, and t FIGS. 4A and 4B top left and right perspective detail views, respectively, showing the nut holder 14 of FIG. 1. In FIG. 4B, the nut feeder 18 is shown as partially removed from the nut loading station 16 for clarity. The nut holder comprises a first nut clamp 50 and a second nut clamp 52. The first nut clamp 50 is adjacent to the rotating disk 36 of the carriage unit 12, and is connected to the rotating gear 28, e.g., by a shaft 54 that passes through an aperture 56 in disk 36. The rotating gear 28 preferably has engagement, such as teeth 58, that will engage with complementary ribs 44 on the belt 32. Therefore, when the rotating gear 28 is turned, it turns the first nut clap 50. The nut clamps 50 and 52 each preferably have a nut engagement surface 60 and 62, respectively which can aid in grasping a nut. The nut engagement surface 60 and 62 can comprise, for example, rubber or plastic pieces that will help prevent the nut from turning relative to the nut clamps 50 and 52, but rather, turn with the nut clamps 50 and 52. The second nut clamp 52 can be carried on a clamp holder 64, and is turnably fitted on a shaft 66 which slidably passes through the clamp holder 64. A catch head 68 is fitted to the other end of shaft 66. The second nut clamp 52, shaft 66 and catch head 68 are preferably biased (e.g. by a spring 70) so that the second nut clamp 52 is biased towards the first nut clamp 50 to thereby capture a nut “N” between the first and second nut clamps 50 and 52, as shown in FIG. 5. The nut holder release unit 24 has an exit 72 through which the catch head 68 will be released so that the biasing spring 70 will bring the second nut cup 52 closer to the first nut cut 50.

FIG. 5 is a rear perspective showing a nut “N” being captured by the nut holder 14. The nut holder release unit 24 has a passageway 80 therethrough which follows a generally semi-circular pathway, and which functions to pull the catch head 68 and thereby pull the shaft 66 and second nut clamp 52 away from first nut clamp 50. At the nut loading station 16, the nut “N” will be positioned to be captured between first and second nut clamps 50 and 52. When the catch head exits the nut holder release unit 24 at its exit 72, the nut “N” will be biased between the first and second nut clamps 50 and 52.

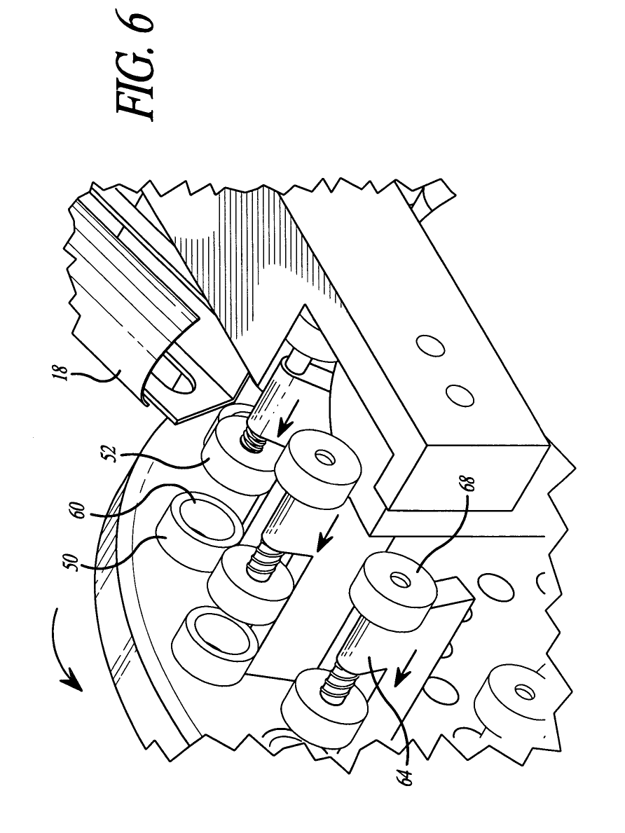

FIG. 6 is a top left perspective view showing the nut holder 24, and shows how the catch head 68 is released from the exit 72 of the nut holder release unit 24.

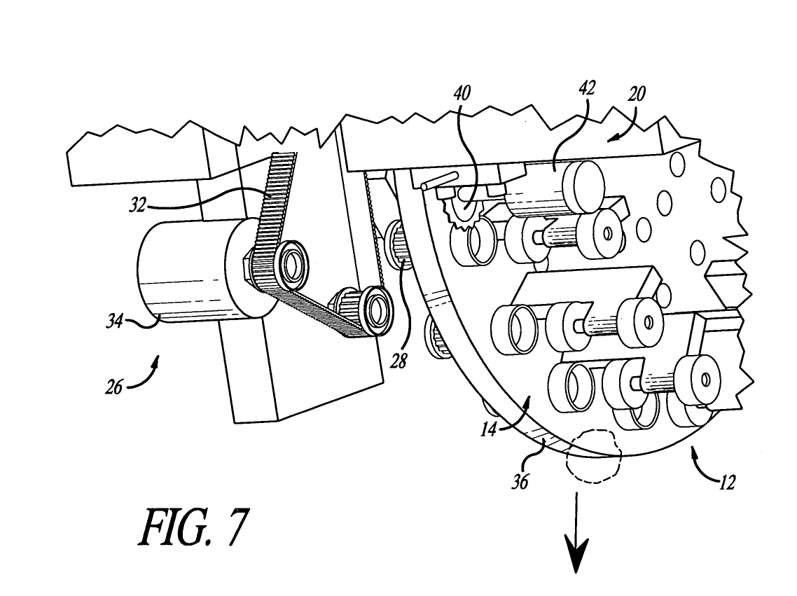

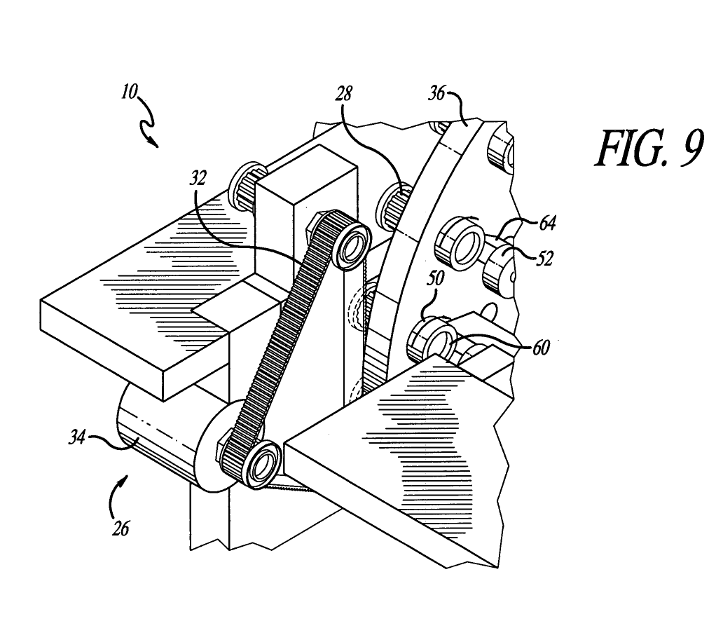

FIG. 7 is a rear bottom perspective view showing the nut rotator 26, its motor 34 and its belt 32, and FIG. 9 is a rear top perspective view showing the nut rotator 26, its motor 34 and its belt 32. Nut holders 14 and the shell cutter 20 with it cutting blade 40 are also shown. A motor 46 turns the cutting blade 40. When the rotating gear 28 impinges on the moving belt 32, the rotating gear 28 will begin to spin and will rotate a nut (not shown) retained by the nut retainer 14. The cutting blade 40 can have a

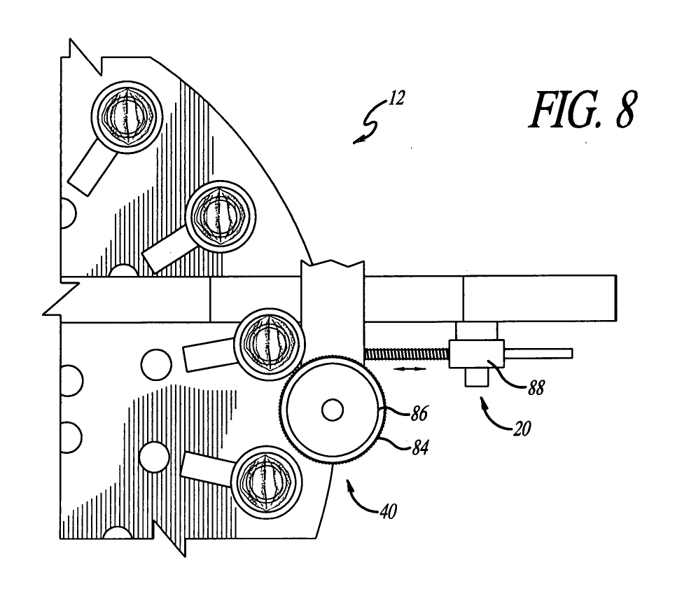

FIG. 8 is a left side detail view showing an exemplary embodiment of the shell cutter 20. In the embodiment shown, the shell cutter 20 has a motor 46 which turns the cutting blade 40. The cutting blade 40 can be a circular saw blade with a cutting edge 84 (e.g. diamond edged) and can have a depth adjustment disc 86 which has a smaller diameter than the cutting edge diameter. The depth adjustment disc 86 can function to ride on the outside of the nut's shell once the cutting edge 84 cuts through the shell to prevent the cutting blade from penetrating too deeply. The motor 46 can preferably by moveably mounted so that the blade 40 will ride on the outside of the nut's shell. This can be accomplished by having the motor pivotally mounted with a biasing mechanism 88.

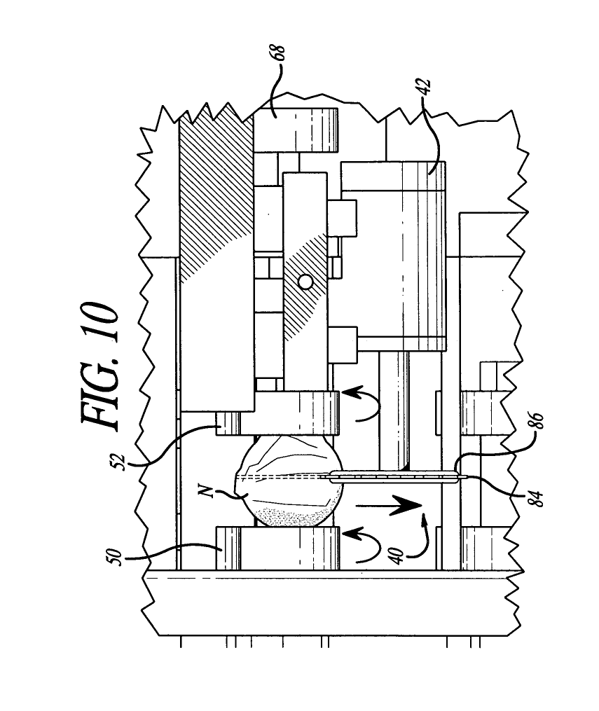

FIG. 10 is a detail showing the shell of a nut N being cut by the blade 40 cutting unit 20, and how the depth adjustment disc 86 functions to ride on the outside of the nut's shell once the cutting edge 84 cuts through the shell to prevent the cutting blade from penetrating too deeply.

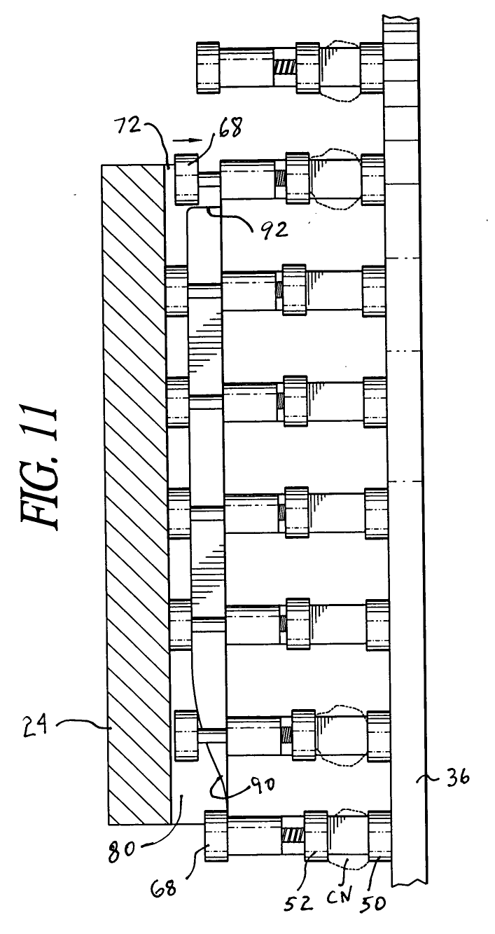

FIG. 11 is a cross-sectional view through the curved view line 11-11 of FIG. 3, and shows the passageway 80, which has an inclined ramp surface 90. As the carried nut holders are rotated on the spindle, the catch head 68 moves into contact with the inclined ramp 90, thereby causing the catch head 68 of the nut holder 14 in that position to be pulled outwardly, thereby pulling the second nut cup 52 away from the first nut cup 50, to release a captured cut nut “CN”. Thereafter, the catch head 68 will continue to ride in passageway 80 in the nut holder release unit 24 until it reaches a release location 92 where the ramp 90 ends, for example, the exit 72. At this point, the biasing spring 70 can return the second nut holder to closer proximity with the first nut holder 50. In normal operations, an uncut nut will be waiting to be captured by the first and second nut holders, and the cycle will begin again.

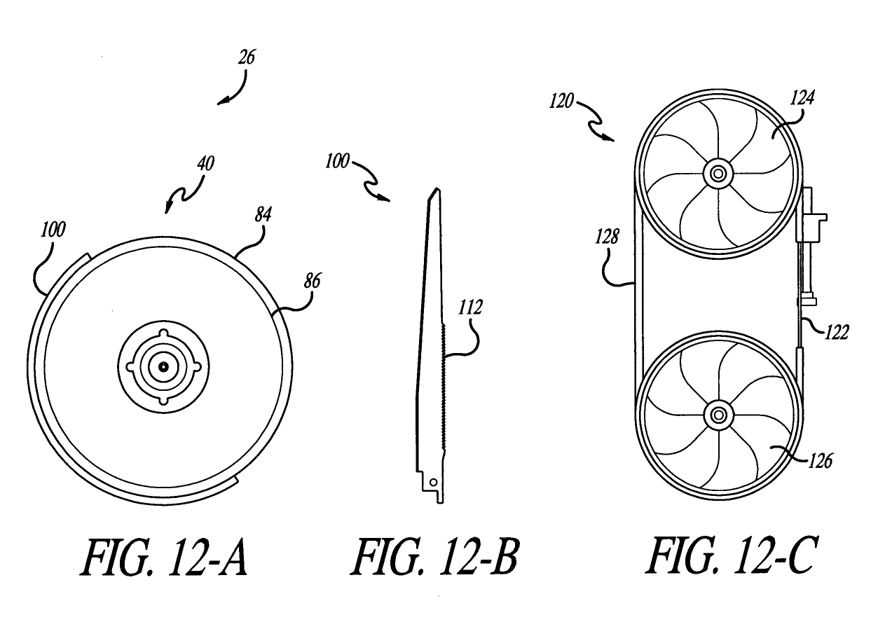

FIGS. 12A-E are details of various cutting devices. FIG. 12A shows a cutting blade 40, that has a generally circular shape with a cutting edge 84 (e.g. diamond edged) and a depth adjustment disc 86 on at least one side of the cutting blade. In fact, this same structure can function as a grinder by modifying the cutting blade to a grinding wheel. A safety guard 100 can be provided. This is the cutting device used above in describing the invention. However, other cutting devices can be used in lieu of a circular saw-type blade, some of which are described with respect to FIGS. 12B-E.

FIG. 12B shows another exemplary embodiment of a cutting device 110 in the form of a serrated straight blade with a cutting edge 112 that can be used in a reciprocating manner to cut through the nut's shell.

FIG. 12C shows an exemplary embodiment of a cutting device 120 in the form of a band saw, which has a band saw blade 122 that moves over band guide wheels 124 and 126. A safety guard 128 can be provided to cover areas of the blade that are not used, if desired.

FIG. 12D shows an exemplary embodiment of a cutting device 130 in the form of a high pressure air cutter that directs a high pressure air stream through a nozzle to cut through the nut's shell.

FIG. 12E shows an exemplary embodiment of a cutting device 140 in the form of a laser cutter that will direct a laser beam to cut through the nut's shell.

Although the embodiment the exemplary embodiment is described as using electric motors to turn the rotating carriage member 12, operate the nut holder rotator 26 and the shell cutter motor 46, other types of motivating devices, such as hydraulic, pneumatic, electro-mechanical motors may be used. Also, while the carriage member 12 is shown as a vertically oriented disk 36 with the nut holders 14 being affixed thereon, the carriage member 12 could be oriented different, e.g. horizontally, etc. In this regard, rather than use a circulating motion disk-shaped carriage member, the carriage member could be some other conveying mechanism, such as linked structures that carry the nut holders from station to station (e.g. nut loading loading station 16, cutting of shell 20, and release the nut with the cut shell). The nut holder 14 is shown as being a basically mechanical structure actuated by springs, etc., it could be operated by electro-mechanical, pneumatic, hydraulic, etc. devices to obviate the nut holder release unit 24.

Having thus described exemplary embodiments of the present invention, it should be understood by those skilled in the art that the above disclosures are exemplary only and that various other alternatives, adaptations and modifications may be made within the scope of the present invention. The presently disclosed embodiments are to be considered in all respects as illustrative and not restrictive.

What is claimed is:

1. A nut de-shelling device, comprising:
a nut holder; and
a nut shell cutter that makes a cut line through the shell of the nut.

2. The nut de-shelling device of claim 1, wherein the nut holder comprises nut holders that are adapted to securely hold nuts of various sizes and shapes.

3. The nut de-shelling device of claim 2, wherein each nut holders comprises two clamping portions that securely hold a nut.

4. The nut de-shelling device of claim 3, wherein the clamping portions are rotatably mounted to a carriage member.

5. The nut de-shelling device of claim 4, wherein the carriage member is rotatable.

6. The nut de-shelling device of claim 4, wherein the carriage member comprises a disk structure.

7. The nut de-shelling device of claim 2, further comprising a releaser to permit nuts whose shell has been cut to be released from the nut holders.

8. The nut de-shelling device of claim 3, further comprising a nut holder releaser that is separates the two clamping portions to permit nuts whose shell has been cut to be released from the nut holders.

9. The nut de-shelling device of claim 1, further comprising a nut feeder portion that is adapted to feed nuts to the nut holding means.

10. The nut de-shelling device of claim 9, further comprising a loading station where nuts are captured by the nut holding means from the nut feeder portion.

11. The nut de-shelling device of claim 9, wherein the nut feeder portion comprises a feed path down which nuts pass to arrive at the loading location.

12. The nut de-shelling device of claim 1, wherein the nut shell cutter is selected from the group consisting of a circular saw, a reciprocating saw, and band saw, a laser cutter, a high pressure air jet cutter, and a grinder.

13. The nut de-shelling device of claim 1, wherein the nut shell cutter is movably mounted to move into contact with the nut to be cut to automatically cut slightly deeper than the thickness of the shell.

14. The nut de-shelling device of claim 4, wherein the clamping portion and the retained nut rotate around an axis of rotation that is generally perpendicular to a plane of the cut line when the shell of the nut is being cut by the shell cutter.

15. The nut de-shelling device of claim 8, wherein after the nut's shell is cut by the cutter, the nut holder releaser will permit the nut to drop.

16. The nut de-shelling device of claim 15, wherein one of the clamping portions is moveable away from the other clamping portion and has an engagement end, and wherein the nut holder releaser means comprises a slanted ramp that contacts the engagement end of the moveable clamping portion and moves it away from the other clamping portion to thereby release the nut.

17. The nut de-shelling device of claim 1, wherein a plurality of nut holders are rotatably mounted to a rotatable carriage member, each nut holder comprising two opposing clamping portions that are adapted to move together relative to each other to securely hold a nut during the conveyance of the nut to the nut shell cutter, and move away relative to each other to release the nut after it's shell has been cut.

18. The nut de-shelling device of claim 17, wherein the two opposing clamping portions comprise cups with grip surfaces that are sized and shaped to engage a nut without regard to the orientation of the nut in the cups, and wherein at least one cup is moveable away from the other cup.

19. The nut de-shelling device of claim 18, wherein the cups are moved together to clamp a nut by mechanism selected from the group consisting of a spring, an electromechanical actuator, an magnetic actuator, a pneumatic actuator, and a hydraulic actuator.

20. The nut de-shelling device of claim 4, further comprising a rotating mechanism, and wherein one of the clamping portions further comprises a drive gear that engages with the rotating mechanism and rotates the clamping portions and the carried nut when the clamping portions and nut are in the vicinity of the cutter.

21. The nut de-shelling device of claim 20, wherein the drive means comprises a moving drive belt.

22. The nut de-shelling device of claim 20, wherein the nut being de-shelled comprises a walnut.

23. A nut de-shelling device, comprising:
a plurality of nut holder carried on a moving carriage member, with each nut holder having a pair of rotatable clamping members that securely hold the nut without regard to the orientation of the nut held therein, but permit rotation of the clamped nut relative to the moving carriage member;
a nut shell cutter that makes a cut line through the shell of the nut; and
a releaser that moves the pair of rotatable clamping members apart from each other to release the nut after its shell has been cut.

24. The nut de-shelling device of claim 23, further comprising a loading station where the nuts are clamped by the pair of rotatable clamping members.

25. The nut de-shelling device of claim 24, further comprising a nut feeder that directs nuts to the loading station.

26. The nut de-shelling device of claim 23, wherein the nut shell cutter is selected from the group consisting of a circular saw, a reciprocating saw, and band saw, a laser cutter, a high pressure air jet cutter, and a grinder.

27. The nut de-shelling device of claim 23, wherein the nut shell cutter is movably mounted to move into contact with the nut to be cut to automatically cut slightly deeper than the thickness of the shell.

28. The nut de-shelling device of claim 23, wherein the clamping members and the retained nut rotate around an axis of rotation that is generally perpendicular to a plane of the cut line when the shell of the nut is being cut by the cutter.

29. The nut de-shelling device of claim 23, wherein after the nut's shell is cut by the cutter, the releaser permits the nut to drop.

30. The nut de-shelling device of claim 23, wherein one of the clamping members is moveable away from the other clamping members and has an engagement end, and wherein the releaser comprises a slanted ramp that contacts the engagement end of the moveable clamping member and moves it away from the other clamping member to thereby release the nut.

31. The nut de-shelling device of claim 23, wherein the two opposing clamping members comprise cups with grip surfaces that are sized and shaped to engage a nut without regard to the orientation of the nut in the cups, and wherein at least one cup is laterally moveable relative to the other cup.

32. The nut de-shelling device of claim 31, wherein the cups are moved together to clamp a nut by moving means selected from the group consisting of a spring, an electromechanical actuator, an magnetic actuator, a pneumatic actuator, and a hydraulic actuator.

33. The nut de-shelling device of claim 23, further comprising a drive mechanism, and wherein one of the clamping portions further comprises a drive gear that engages with the drive mechanism and rotates the clamping portions and the carried nut when the clamping portions and nut are in the vicinity of the cutting means.

34. The nut de-shelling device of claim 23, wherein the drive means comprises a moving drive belt.

35. The nut de-shelling device of claim 23, wherein the nut being de-shelled comprises a walnut.

36. A nut de-shelling device, comprising:
a nut holder; and
a nut shell saw that makes a saw line through the shell of the nut.

37. The nut de-shelling device of claim 36, further comprising a loading station where the nuts are secured by the nut holder.

38. The nut de-shelling device of claim 37, further comprising a nut feeder that directs nuts to the loading station.

39. The nut de-shelling device of claim 36, wherein the nut shell saw is movably mounted to move into contact with the nut to be cut to automatically cut slightly deeper than the thickness of the shell.

40. The nut de-shelling device of claim 36, wherein the nut holder and the retained nut rotate around an axis of rotation that is generally perpendicular to a plane of the saw line when the shell of the nut is being cut by the shell saw.

41. The nut de-shelling device of claim 36, further comprising nut releaser that permits the sawed nut to drop.

42. The nut de-shelling device of claim 36, further comprising drive mechanism for rotating the nut holder and the held nut when the nut's shell is being sawed.

43. The nut de-shelling device of claim 36, wherein the nut being de-shelled comprises a walnut.

44. A method for de-shelling nuts, comprising the steps of:
holding a nut; and
sawing a saw line through the shell of the nut around a perimeter of the nut.

45. The method for de-shelling nuts of claim 44, wherein the nut comprises a walnut, and the sawing step is carried out by a circular saw.

46. The method for de-shelling nuts of claim 44 wherein during the sawing step the nut is rotated.
